(19) United States
(12) Patent Application Publication
(10) Pub. No.: US 2012/0027988 A1
(43) Pub. Date: Feb. 2, 2012

(54) PRINTED EMBLEM FOR SECURING TO A FIRST FABRIC

(75) Inventor: Carl JURNOVOY, Philadelphia, PA (US)

(73) Assignee: PENN EMBLEM COMPANY, Philadelphia, PA (US)

(21) Appl. No.: 12/844,956

(22) Filed: Jul. 28, 2010

(51) Int. Cl. B32B 3/06; B32B 38/00

(52) U.S. Cl. 428/103; 156/93

(57) ABSTRACT

A printed emblem for being securing to a first fabric includes a fabric base having a front surface and a rear surface. The fabric base is made of the same or substantially the same material as the first fabric and has the same or substantially the same weave pattern and color as the first fabric. An emblem design is printed onto the fabric base. A stitched border extends around the periphery of the fabric base, the border being made using a relatively small sized needle and a relatively thin, dull yarn which is the same or substantially the same color as the color of the fabric base so that the border is relatively small and fades into the fabric base so as to be nearly invisible. A layer of thermoplastic adhesive material is bonded to the rear surface of the fabric base for securing the emblem to the first fabric.

### BACKGROUND OF THE INVENTION

The present invention relates to a printed emblem and a method of making a printed emblem and, in particular, a printed emblem and a method of making a printed emblem having an appearance so that when the emblem is applied to the fabric of a garment or the like, it appears as though the design of the emblem has been printed directly onto the fabric of the garment.

In general, embroidered emblems and methods for making embroidered emblems are well known in the art. A particular embroidered emblem and method of making the embroidered emblem is disclosed in U.S. Pat. Nos. 3,657,060 entitled “Embroidered Emblem With Thermoplastic Adhesive” and 3,816,211 entitled “Method For Making Embroidered Emblem” both of which are owned by the assignee of the present application. These two related patents disclose an embroidered emblem 110 of the type shown in FIGS. 1 and 2 of the present application and which comprises a fabric base 112 with an embroidered design 114, including an embroidered border 114a extending around the outer periphery on at least a front or first principal surface 116 of the fabric base 112 and a layer of a thermoplastic adhesive material 118 laminated or bonded to the rear or second principal surface 120 of the fabric base 112. In this manner, the embroidered emblem 110 can be conveniently fastened to a garment or other fabric surface through the application of at least one of heat and pressure to melt the thermoplastic material 118 and thereby bond the fabric base 112 to a garment, hat or other fabric surface. A similar emblem and method is disclosed in U.S. Pat. No. 4,981,742. The subject matter of each of the three above-mentioned patents is hereby incorporated by reference into the present application.

While the emblems disclosed in the three above-mentioned patents are quite acceptable and while the methods disclosed in the above referenced patents are quite useful in manufacturing such emblems, there was a need for an emblem which provides an enhanced appearance when secured to a garment or other fabric. In particular, there was a need for an embroidered emblem which has a fabric base which is the same as or substantially the same as the fabric of the garment or other fabric surface to which the emblem was to be secured so that when the embroidered emblem was secured to the garment or other fabric surface the fabric base blends in with the garment or other fabric surface so that it appears as though the embroidered design of the emblem was embroidered directly onto the garment or other fabric surface. For example, in some industries in which employees wear uniforms, the uniforms may have one or more embroidered emblems such as a company logo or employee name applied to the uniform shirt or jacket. Typically the names or other personalized information of the employees are embroidered directly onto the uniform shirt or jacket to provide a cleaner, neater appearance. Direct embroidery of an employee name in this manner adds substantial expense to the cost of the garment and, because removal of such direct embroidery is not feasible, precludes the garment from being re-used by another employee when the named employee leaves the company.

U.S. Pat. No. 7,467,593 entitled “Embroidered Emblem for Securing to a First Fabric” (owned by the assignee of the present application and incorporated herein by reference) discloses an embroidered emblem 210 (shown in FIGS. 3-6) which like the above described prior art embroidered emblems 110 includes a fabric base 212 having a front or first principal surface 216 and a rear or second principal surface 220, an embroidered design 214, including a border 214a, stitched or embroidered into at least the front surface 216 of the fabric base 212 and a layer of thermoplastic adhesive material 218 bonded to the rear surface 220 of the fabric base 212 for securing the emblem to the fabric 230 of a garment or other article. Unlike the above described prior art embroidered emblems 110, the embroidered emblem 210 of the '593 patent includes a fabric base 212 which is made of the same or substantially the same material as the fabric 230 (referred to as the “first fabric”) of the shirt, jacket, hat or other garment or article to which the emblem 210 is to be attached. In particular, the fabric base 212 of the embroidered emblem 210 includes the same or substantially the same weave pattern and color as the first fabric 230 so that when the emblem 210 is secured to the first fabric 230 (FIGS. 5 and 6), the fabric base 212 of the emblem 210 blends with the first fabric 230 so that the fabric base 212 of the emblem 210 is nearly invisible and the embroidered emblem design 114 appears to have been applied directly to the garment or other article to which the emblem 210 has been secured.

There is also a substantial difference in the border 214a. With the above described prior art embroidered emblems 110, the embroidered border 114a, which is located around the outer or peripheral edge of the fabric base 112, is typically made at the same time as the remainder of the embroidered design 114 using the same needle, and a yarn color (typically a color used in the embroidered design) which typically contrasts with the color of the fabric base 112 and is of a thickness and/or width which corresponds to the thickness or width of the remainder of the embroidered design (see 114a of FIGS. 1 and 2 of the present application). In this manner, the border 114a serves as a frame to encircle and highlight the fabric base 112 and the remainder of the embroidered design 114. In contrast, with the emblem 210 of the '593 patent, the stitched border 214a is made using a relatively small sized embroidery needle (much smaller that the needle used to make the remainder of the embroidered design 214) and is made using a yarn which is not the same as the yarn used to make the embroidered design 214. In particular, the yarn used to make the border 214a is relatively thin and is the same or substantially the same color as the color of the fabric base 212 and the first fabric 230. In this manner, when the emblem 210 is secured to the garment or other article, the much smaller sized border 214a fades into the fabric base 212 and the first fabric 230 of the garment or other article so that the border 214a is nearly invisible thus helping to give the appearance that the embroidered emblem design 214 has been applied directly to the first fabric 230 of the garment or other article.

The present invention provides a printed emblem which includes many of the features of the embroidered emblem 210 of the '593 patent. In particular, a printed emblem made in accordance with the present invention, when applied to a garment or other article has the appearance of the printed design having been printed direct onto the garment or other article but which is much easier to apply to the garment and which can be conveniently and completely removed from the garment to permit re-use of the garment and the printed emblem. A printed emblem in accordance with the present invention is also less expensive to produce than an embroidered emblem.

### BRIEF SUMMARY OF THE INVENTION

Briefly stated, the present invention, in one embodiment, comprises a printed emblem for being securing to a first fabric by the application of at least one of heat and pressure, the first fabric being made of a material having a predetermined weave pattern and at least one predetermined color. The emblem is comprised of a fabric base having a front surface and a rear surface. The fabric base is made of the same or substantially the same material as the first fabric and has the same or substantially the same weave pattern and color as the first fabric. An emblem design is printed onto the front surface of the fabric base. A stitched border extends around the outer periphery of the fabric base, the border being made using a relatively small sized needle and a relatively thin, dull yarn which is the same or substantially the same color as the color of the fabric base so that the border is relatively small and fades into the fabric base so as to be nearly invisible. A layer of thermoplastic adhesive material is bonded to the rear surface of the fabric base for securing the emblem to the first fabric.

In another embodiment, the present invention comprises a method of making a printed emblem for securing to a first fabric by the application of at least one of heat and pressure, the first fabric being made of a material having a predetermined weave pattern and at least one predetermined color. The method comprises the steps of: providing a fabric base having a front surface and a rear surface, the fabric base being of the same or substantially the same material as the first fabric and having the same or substantially the same weave pattern and color as the first fabric; printing an emblem design onto the front surface of the fabric base; stitching a border around the outer periphery of the fabric base, the border being made using a relatively small sized needle and a relatively thin, dull yarn which is the same or substantially the same color as the color of the fabric base so that the border is relatively small and fades into the fabric base so as to be nearly invisible; and bonding a layer of thermoplastic adhesive material to the rear surface of the fabric base for securing the emblem to the first fabric.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a top plan view of an embroidered emblem in accordance with the prior art;

FIG. 2 is a side sectional view of the prior art emblem shown in FIG. 1 taken along line 2-2 of FIG. 1;

FIG. 3 is a top plan view of another embroidered emblem in accordance with the prior art;

FIG. 4 is a side sectional view of the prior art emblem shown in FIG. 3 taken along line 4-4 of FIG. 3;

FIG. 5 is a top plan view of the prior art emblem shown in FIG. 3 after the emblem has been secured to a first fabric of a garment.

FIG. 6 is a side sectional view of the prior art emblem shown in FIG. 5 taken along line 6-6 of FIG. 5;

FIG. 7 is a top plan view of a screen printed emblem in accordance with a first preferred embodiment of the present invention;

FIG. 8 is a side sectional view of the emblem shown in FIG. 7 taken along line 8-8 of FIG. 7;

FIG. 9 is a top plan view of the emblem shown in FIG. 7 after the emblem has been secured to a first fabric of a garment;

FIG. 10 is a side sectional view of an ink jet printed emblem in accordance with a second preferred embodiment of the present invention; and

FIG. 10A is an enlarged view of the circled portion of FIG. 10.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the emblem and designated parts thereof. Unless specifically set forth herein, the terms “a”, “an” and “the” are not limited to one element but instead should be read as meaning “at least one”. The terminology includes the words noted above, derivatives thereof and words of similar import.

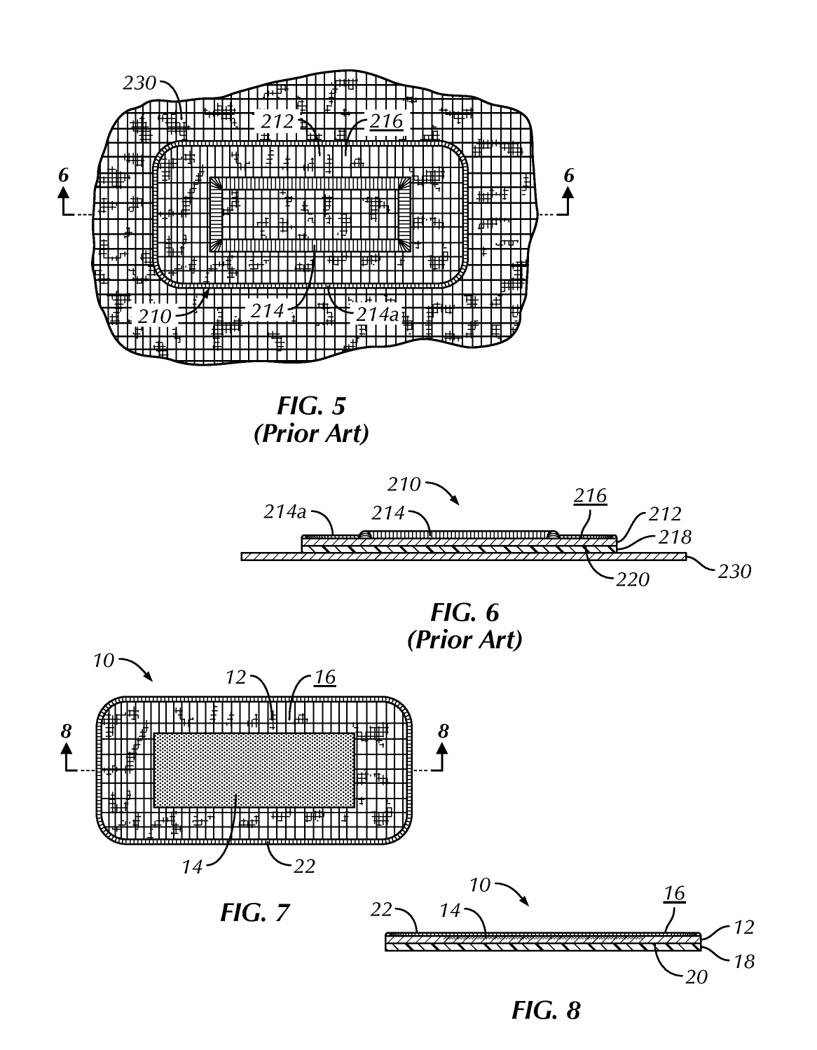

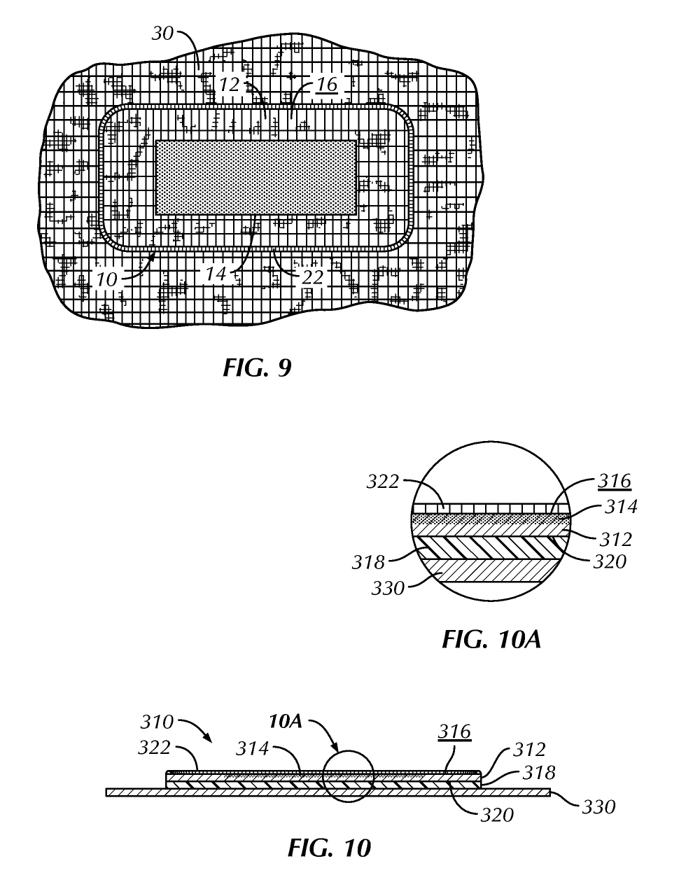

Referring now to the drawings, there is shown in FIGS. 7, 8 and 9, a first preferred embodiment of a printed emblem, generally 10, for securing to a first fabric 30 by the application of at least one of heat and pressure in a manner as described in detail in the above-identified U.S. patents. The fabric 30 may be a portion of a garment, such as a shirt, smock, apron, hat or any other article of clothing. Alternatively, the fabric 30 may be some other article such as a banner, flag or any other article formed of the first fabric 30. Further, while it is preferred that the first fabric 30 be comprised of a woven textile fabric such as 100% polyester, 100% cotton or a polyester/cotton blend thereof, preferably about 65% polyester and about 35% cotton, it should be clearly understood that the first fabric 30 may be made of any type of natural or synthetic textile material using techniques which are known to those of ordinary skill in the art. In short, the first fabric 30 may comprise virtually any suitable woven fabric which may or may not be coated or impregnated with one or more soil resisting or stain repellent treatments and may be colored utilizing standard textile dyes of a type well known to those of ordinary skill in the art. The first fabric 30 as show in FIG. 9 is comprised of a textile material having a predetermined weave pattern and at least one predetermined color. The particular weave pattern utilized in forming the first fabric 30 should not be considered to be a limitation on the present invention nor should the particular color of the first fabric 30. Accordingly, it should be clearly understood that the printed emblem 10 in accordance with the present invention may be secured to a first fabric 30 having any type of weave pattern and any desired color without departing from the scope and spirit of the present invention.

As shown in FIGS. 7 and 8, the printed emblem 10 in accordance with the first preferred embodiment is comprised of a fabric base 12 having a first principal or front surface 16 and a second principal or rear surface 20. In the present embodiment the fabric base 12 is generally rectangularly shaped in plan view. It will be appreciated by those of ordinary skill in the art that the shape of the fabric base 12 as well as the size of the fabric base 12 may vary in particular applications. More specifically, the fabric base 12 may be circular, square, triangular or any other desired shape. As can be seen when viewing FIGS. 7 and 9, the fabric base 12 is preferably made of the same or substantially the same material or fabric as the first fabric 30. The fabric base 12 preferably has the same or substantially the same weave pattern as that of the first fabric 30 and is of the same or substantially the same color as the color of the first fabric 30. Most preferably, the fabric base 12 is of the exact same material as the first fabric 30. This feature of the present invention is particularly important because when a printed emblem 10 in accordance with the first embodiment of the present invention is secured to the first fabric 30 the fabric base 12 should precisely match the first fabric 30 so that the fabric base 12 blends in with and substantially disappears into the first fabric 30.

The emblem 10 further includes an emblem design 14 which has been printed onto the front surface 16 of the fabric base 12 using a standard screen printing process in the manner well known in the art. As best shown in FIG. 8, the screen printed emblem design 14 essentially forms a thin layer on the front surface 16 of the fabric base 12. As shown in FIG. 7 and 8, for purposes of illustrating the present embodiment the printed emblem design 14 is in the form of a generally rectangular pattern. It will be appreciated by those of ordinary skill in the art that the generally rectangularly shaped printed emblem design 14 is presented only for purposes of illustrating the present invention and should not be considered to be a limitation on the present invention. Virtually any other type of printed emblem design including designs of different shapes and sizes as well as different colors or a combination of colors may alternatively be used.

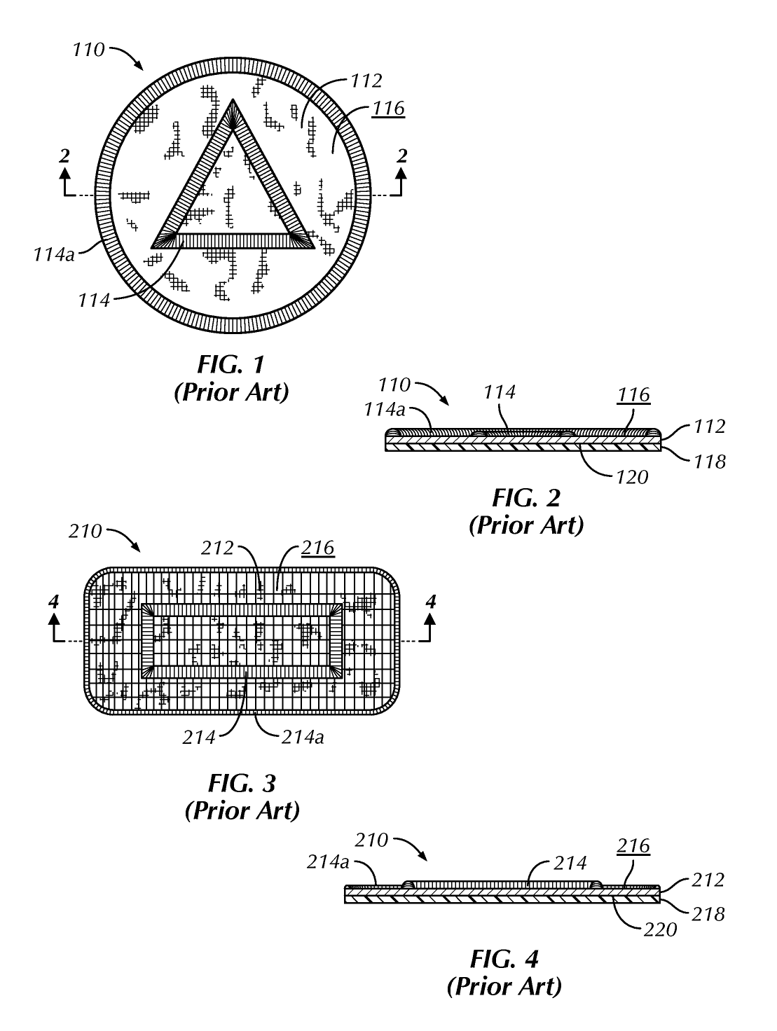

The emblem 10 also includes a stitched border 22 extending around the outer periphery of at least the front surface 16 of the fabric base 12. The border 22 is made utilizing a relatively small sized needle and a relatively thin yarn which preferably is the same or substantially the same color as the color of the fabric base 12 but which preferably is at least slightly duller. Typically, in the above described prior art emblem 110 the border 114a is a Merrow border which is typically made using a continuous filament 100% polyester extremely bright yarn typically in size 300/4's-1200 Denier. Typically a large needle, such as a number 3DST needle is used to make such a Merrow border. The Merrow border 114 is bright and is very heavy and broad and quite visible as shown in FIGS. 1 and 2. The border 22 of the present emblem 10, as described in the '593 patent, is a stitched border which is made using a much smaller 100% spun polyester intentionally dull yarn in size Tex 27-60.5 Denier. The needle employed for forming the stitched border 22 is preferably a number DBXK5 needle which is much smaller than the needle used for the Merrow border 114a. By making a stitched border 22 utilizing a relatively small sized needle and by utilizing a relatively thin intentionally dull yarn which is the same or substantially the same color as that of the fabric base 12, the border 22 is relatively small and fades into the fabric base 12 and also fades into the first fabric 30 to become practically invisible when the emblem 10 has been secured to the first fabric 30 as shown in FIG. 9.

The emblem 10 further includes a layer of thermoplastic adhesive material 18 which is laminated or bonded to the rear surface 20 of the fabric base 12. The thermoplastic adhesive material 18 is preferably a polyurethane which is the same as or substantially the same as the thermoplastic adhesive material described in detail in the above-identified patents and is bonded to the rear surface 20 of the fabric base 12 in the manner described in the above-identified U.S. patents. The layer of thermoplastic adhesive material 18 is used for securing the emblem 10 to the first fabric 30 by the application of at least one of heat and pressure in the manner described in detail in the above-identified U.S. patents.

The emblem 10 may be made as a single emblem, an entire sheet containing multiple emblems, or may be made at one time with each of the individual emblems being thereafter die cut or otherwise cut from the remainder of the emblem sheet. If desired, the individual emblems 10 may be finished by singeing the peripheral edge of the emblem 10 using a heat source of a type well known in the art to seal the fibers along the outer edge of the fabric base 12 and thereby prevent any threads from the emblem 10 from unraveling during laundering of the first fabric 30 to which the emblem 10 has been secured.

FIG. 9 shows the emblem 10 in accordance with the first preferred embodiment secured to the first fabric 30. As can be seen, because the fabric base 12 is formed of the same or substantially the same material as the first fabric 30 and has the same or substantially the same weave pattern and color as the first fabric 30 and because the stitched border 22 is relatively small and is of the same or substantially the same color as the fabric base 12 and the first fabric 30, the emblem 10 blends in with the first fabric 30 so as to be nearly invisible. In this manner, the printed emblem design 14 appears as though it has been printed directly onto the first fabric 30. Of course, as is well known in the art and as described in detail in the above-identified U.S. patents, the emblem 10 may be conveniently and cleanly removed from the first fabric 30 through the application of at least one of heat and pressure thereby permitting reuse of the first fabric 30 with our without the application of another emblem.

FIGS. 10 and 10A show a second preferred embodiment of a printed emblem, generally 310, for securing to a first fabric 330 by the application of at least one of heat and pressure in a manner as described in detail in the above-identified U.S. patents. The printed emblem 310 is substantially the same as the above-described printed emblem 10 of the first embodiment with the exception of the manner in which the emblem design 314 is printed. More specifically, the emblem 310 includes a fabric base 312 which is made of the same or substantially the same material as the first fabric to which the emblem 310 is to be attached and is preferably made of 100% polyester. Alternatively, the fabric base 312 could be made of 100% cotton or a blend of polyester and cotton in the same manner as the above-described fabric base 12. The fabric base 312 includes a front surface 316, a rear surface 320 a stitched border 322 which is the same as the stitched border 22 of the emblem 10 of the first embodiment and a layer of thermoplastic adhesive material 318 bonded to the rear surface 318 as with the emblem of the first embodiment 10. The only substantial difference between the emblems of the first embodiment 10 and the second embodiment 310 is that the emblem design 314 in the second embodiment is printed onto the front surface 316 of the fabric base 312 using an ink jet printing process.

The ink jet printing process used to apply the emblem design 314 to the front surface 316 of the fabric base 312 is of a type well known in the emblem making art. As best shown in FIG. 10A, the ink jet printed emblem design 314 is at least partially embedded into the fibers of the front surface 316 of the fabric base 312 to provide the emblem design 314 with an appearance which is slightly different from the appearance of the emblem design 14 of the first embodiment 10. Like the emblem 10 of the first embodiment, for purposes of illustrating the present embodiment the printed emblem design 314 is also in the form of a generally rectangular pattern. It will be appreciated by those of ordinary skill in the art that the generally rectangular shaped printed emblem design 314 is presented only for purposes of illustrating the present invention and should not be considered to be a limitation on the present invention. Virtually any other type of printed emblem design including designs of different shapes and sizes as well as different colors or a combination of colors may alternatively be used. In all other respects, the emblem 310 of the second embodiment is the same as the emblem 10 of the first embodiment.

It will be appreciated by those skilled in the art that changes could be made to the embodiment described above without departing from the broad inventive concepts thereof. It is understood, therefore, that this invention is not limited to the particular embodiment disclosed, but it is intended to cover all modifications within the spirit and scope of the present invention as defined by the appended claims.

I/we claim:

1. A printed emblem for securing to a first fabric by the application of at least one of heat and pressure, the first fabric being made of a material having a predetermined weave pattern and at least one predetermined color, the emblem comprising:
a fabric base having a front surface and a rear surface, the fabric base being of the same or substantially the same material as the first fabric and having the same or substantially the same weave pattern and color as the first fabric;
an emblem design printed onto the front surface of the fabric base;
a stitched border extending around the outer periphery of the fabric base, the border being made using a relatively small sized needle and a relatively thin, dull yarn which is the same or substantially the same color as the color of the fabric base so that the border is relatively small and fades into the fabric base so as to be nearly invisible; and
a layer of thermoplastic adhesive material bonded to the rear surface of the fabric base for securing the emblem to the first fabric.

2. A printed emblem as recited in claim 1 wherein the emblem design is printed onto the front surface of the fabric base using one of a screen printing process and an ink jet printing process.

3. A printed emblem as recited in claim 1 wherein the needle employed for making the stitched border is a number DBXK5 needle.

4. A printed emblem as recited in claim 1 wherein the yarn used for making the stitched border is a 100% spun polyester yarn in size Tex 27-60.5 Denier.

5. A printed emblem as recited in claim 1 wherein the first fabric and the fabric base comprise a woven fabric selected from the group consisting of polyester, cotton and combinations thereof.

6. A printed emblem as recited in claim 1 wherein the thermoplastic adhesive material is polyurethane.

7. A method of making a printed emblem for securing to a first fabric by the application of at least one of heat and pressure, the first fabric being made of a material having a predetermined weave pattern and at least one predetermined color, the method comprising:
providing a fabric base having a front surface and a rear surface, the fabric base being of the same or substantially the same material as the first fabric and having the same or substantially the same weave pattern and color as the first fabric;
printing an emblem design onto the front surface of the fabric base;
stitching a border around the outer periphery of the fabric base, the border being made using a relatively small sized needle and a relatively thin, dull yarn which is the same or substantially the same color as the color of the fabric base so that the border is relatively small and fades into the fabric base so as to be nearly invisible; and
bonding a layer of thermoplastic adhesive material to the rear surface of the fabric base for securing the emblem to the first fabric.

8. The method of making a printed emblem as recited in claim 7 where the emblem design is printed onto the front surface of the fabric base using one of a screen printing process and an ink jet printing process.
